(19) United States
(12) Patent Application Publication
(10) Pub. No.: US 2026/0353029 A1
(43) Pub. Date: Nov. 5, 2026

(54) INFORMATION PRESENTATION APPARATUS, AND PROGRAM

(71) Applicant: NTT, Inc., Tokyo (JP)

(72) Inventors: Tatsuya KAKO, Musashino-shi, Tokyo (JP); Hironobu CHIBA, Musashino-shi, Tokyo (JP); Kenichi NOGUCHI, Musashino-shi, Tokyo (JP); Akira NAKAYAMA, Musashino-shi, Tokyo (JP)

(73) Assignee: NTT, Inc., Tokyo (JP)

(21) Appl. No.: 19/487,018

(22) PCT Filed: Jun. 9, 2023
(86) PCT No.: PCT/JP2023/021449

§ 371 Date: Nov. 24, 2025

(51) Int. Cl. H04S 7/00; G10L 21/0388; G10L 25/78; H04R 1/10

(52) U.S. Cl. CPC H04S 7/307; G10L 21/0388; G10L 25/78; H04R 1/1016; H04S 2400/11

(57) ABSTRACT

To cause a user of earphones capable of simultaneously hearing an ambient sound and an information sound to distinguish the information sound from the ambient sound. Therefore, an information presentation apparatus according to a first aspect of the disclosed technology includes a signal processor that converts an information sound into an identifiable signal. The identifiable signal is a signal obtained by subjecting the information sound to stereophonic sound processing or a signal obtained by changing a tone of the information sound. Furthermore, an information presentation apparatus according to a second aspect of the disclosed technology includes a signal processor and a peripheral device. The signal processor generates distinguishing information from the information sound. The peripheral device operates according to the distinguishing information, or displays the distinguishing information.

### TECHNICAL FIELD

The disclosed technology relates to a technology for users of earphones that do not block surrounding sound. It allows the users to distinguish earphone sound from the surrounding sound.

### BACKGROUND ART

In order to present information to users by sound respectively, installation of a speaker or wearing of earphones is essential. Hereinafter, a sound presented to the user through the speaker or the earphones will be referred to as an “information sound”.

In a case where the information sound is presented by the speaker, a place where the information sound can be presented is limited to a place where the speaker is installed. Further, the speaker cannot present the information sound to a specific user.

It is possible to present the information sound to the specific user by the earphones, but it becomes difficult for the user to capture surrounding sound when he/she wears common earphones. Hereinafter, a sound around the earphone user is referred to as an “ambient sound”.

As a technology for capturing the ambient sound, for example, there are hear-through type earphones (for example, Non Patent Literature 1). The hear-through type earphones pick up an ambient sound with a microphone built in the earphones, reproduces the ambient sound with a driver unit of the earphone, and supplies the ambient sound to ear canals together with an information sound. It is also possible to turn off a hear-through function to block the ambient sound. Since the hear-through type earphones use the sound through the microphone, a tone of the captured ambient sound may change. In addition, since the hear-through type earphones are worn to block external acoustic openings like normal earphones, it is difficult for surrounding people to talk to a user of the hear-through type earphones.

As a method for solving these problems, there is a method of using open-ear type earphones (for example, Non Patent Literature 2). The open-ear type earphones refer to earphones of a type in which external acoustic openings are not blocked when worn and ambient sound directly reaches eardrums.

### PRIOR ART LITERATURE

### Non Patent Literature

Non Patent Literature 1: SONY, LinkBuds S, features, “Balancing both ”listening while working“ which is realized by the best external sound capture performance SONY ever had on perfect wireless earphone, and ”immersion“ which is realized by high performance noise cancelling”, [searched on May 22, 2023], the Internet, <https://www.sony.jp/headphone/products/LinkBuds_S/feature_2.html>

Non Patent Literature 2: nwm, MWE-001 product page, [searched on May 22, 2023], the Internet, <https://www.nwm.global/mwe001>

### SUMMARY OF THE INVENTION

### Problems to be Solved by the Invention

When open-ear type earphones are used, since external acoustic openings are not blocked, an ambient sound naturally enters ears, naturally mixes with an information sound emitted by the earphones, and the sound can be heard without discomfort. However, it sometimes becomes difficult for a user of the open-ear type earphones to determine whether the sound the user hears is an information sound or an ambient sound.

Note that the case where it is difficult to determine whether the sound the user hears is an information sound or an ambient sound is similarly applied to the hear-through type earphones.

### Means to Solve the Problems

In order to solve the above problem, an information presentation apparatus according to a first aspect of the disclosed technology includes a signal processor that converts an information sound into an identifiable signal. The identifiable signal is a signal obtained by subjecting the information sound to stereophonic sound processing or a signal obtained by changing a tone of the information sound.

In order to solve the above problem, an information presentation apparatus according to a second aspect of the disclosed technology includes a signal processor and a peripheral device. The signal processor generates distinguishing information from the information sound. The peripheral device operates according to the distinguishing information. Alternatively, the distinguishing information is displayed.

### Effects of the Invention

According to the disclosed technology, a user of earphones capable of simultaneously hearing an ambient sound and an information sound can distinguish the information sound from the ambient sound.

### BRIEF DESCRIPTION OF THE DRAWINGS

FIG. 1 is a diagram illustrating an example of a use scene and a system configuration according to a first embodiment.

FIG. 2 is a functional block diagram of an information presentation apparatus according to the first embodiment.

FIG. 3 is a diagram illustrating an example of a use scene and a system configuration according to a second embodiment.

FIG. 4 is a functional block diagram of an information presentation apparatus according to the second embodiment.

FIG. 5 is a functional block diagram of an information presentation apparatus according to a third embodiment.

FIG. 6 is a functional block diagram of an information presentation apparatus according to a fourth embodiment.

FIG. 7 is a diagram illustrating an example of a use scene and a system configuration according to a fifth embodiment.

FIG. 8 is a functional block diagram of an information presentation apparatus according to the fifth embodiment.

FIG. 9 is a functional block diagram of an example of a system configuration and an information presentation apparatus according to a sixth embodiment.

FIG. 10 is a functional block diagram of an example of a system configuration and an information presentation apparatus according to a seventh embodiment.

FIG. 11 is a diagram illustrating a functional configuration example of a computer.

### DETAILED DESCRIPTION OF THE EMBODIMENTS

Hereinafter, embodiments of the disclosed technology will be described in detail. Note that components having the same function are denoted by the same number, and redundant description will be omitted.

Hereinafter, earphones of a type capable of simultaneously hearing an ambient sound and an information sound, such as hear-through type earphones or open-ear type earphones, are referred to as “open earphones”.

The disclosed technology controls an information sound emitting from the open earphones or controls a peripheral device in conjunction with the information sound so that a user of the earphones can easily recognize that the sound is an “information sound”.

For this purpose, for example, a position of a sound image of the information sound may be controlled.

There is a technology called sound image localization in which an information sound supplied from earphones causes a user of the earphones to hear as if the information sound has a sound source in a specific direction or position in a three-dimensional space.

For example, an ambient sound often has a sound source mainly at a position lower than a horizontal plane or a line of sight, and the sound hardly comes from above the line of sight. Therefore, let a sound image of the information sound localize above the line of sight, and sound image positions of the ambient sound and the information sound be separated. This allows the user of the earphones to distinguish the information sound from the ambient sound.

More generally, the ambient sound may be collected by a microphone capable of measuring a sound source position to specify a position (direction or distance) of the main ambient sound, and the information sound may be localized at a position different from that of the ambient sound. Hereinafter, a method of determining and presenting the sound image position of the information sound in the open earphones described above will be referred to as a “sound image separation method”.

Alternatively, for example, a tone of the information sound may be controlled.

In earphones capable of playing a wideband audio (50 Hz to 7 kHz), quality of a played information sound is comparable to that of the ambient sound, and the sounds cannot be distinguished. So, the information sound is low-pass filtered to the telephone band (300 Hz to 3.4 kHz) and played. Alternatively, noise is intentionally mixed into the playback sound from the earphones to distinguish the playback sound from the ambient sound. For example, comfort noise may be used as the noise.

Alternatively, for example, the open earphones may be vibrated in conjunction with the information sound. During the playback of the information sound, vibration may be continuously performed, or vibration may be intermittently performed.

Alternatively, for example, the information sound may be displayed as text on playback screens of VR glasses. Alternatively, the playback screens of the VR glasses may be notified that the information sound is being played.

Hereinafter, an apparatus that realizes the above information presentation method will be described in detail together with specific application examples.

### First Embodiment: Simultaneous Interpretation

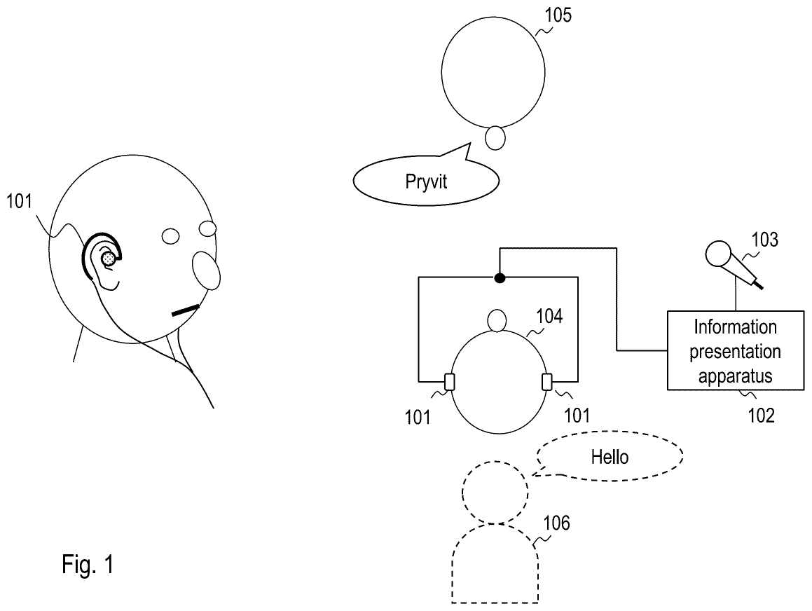

FIG. 1 is a diagram illustrating an example of a use scene and a system configuration according to a first embodiment. Reference numeral 101 denotes an open earphone, reference numeral 102 denotes an information presentation apparatus, reference numeral 103 denotes a microphone, reference numeral 104 denotes a Japanese speaker, reference numeral 105 denotes a foreign language speaker, and reference numeral 106 denotes a virtual interpreter.

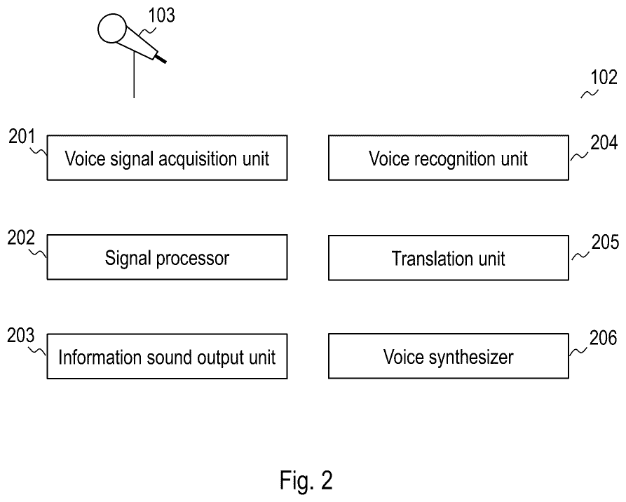

FIG. 2 is a functional block diagram illustrating a configuration example of the information presentation apparatus 102 according to the first embodiment. The information presentation apparatus 102 includes a voice signal acquisition unit 201, a signal processor 202, an information sound output unit 203, a voice recognition unit 204, a translation unit 205, and a voice synthesizer 206.

The foreign language speaker 105 and the Japanese speaker 104 have a conversation. During the conversation, voice of the foreign language speaker 105 is acquired as a voice signal by the microphone 103 and the voice signal acquisition unit 201. The acquired voice signal is converted into text by the voice recognition unit 204, and is translated into Japanese text by the translation unit 205. The voice synthesizer 206 converts the Japanese text into a Japanese voice signal. The signal processor 202 performs predetermined processing on the Japanese voice signal, and the information sound output unit 203 outputs the Japanese voice signal to the open earphones 101. The open earphones 101 allow a user to talk while naturally listening to the voice of speaker 105 and listening to a translation result without blocking ears.

The signal processor 202 performs sound image localization on translated voice (output of the voice synthesizer 206) and localizes a sound image behind the Japanese speaker 104 as if the virtual interpreter 106 were behind the Japanese speaker. Alternatively, the sound image is localized in a direction of the foreign language speaker 105. By such stereophonic sound processing, the translated voice (information sound) is dominantly heard by the open earphone user.

Note that the sound image localization by the signal processor 202 may utilize the sound image separation method instead.

### Second Embodiment: Tourist Information

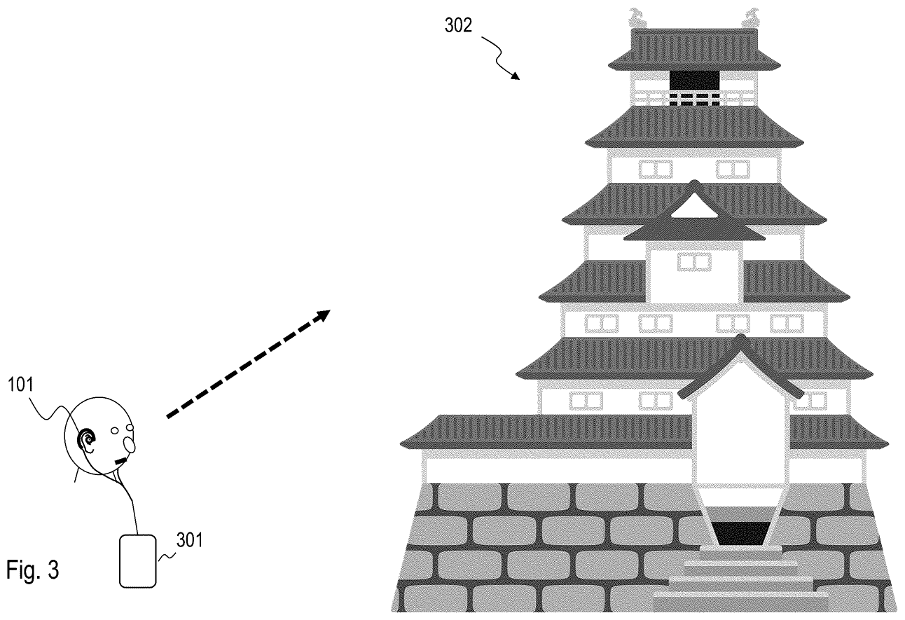

FIG. 3 is a diagram illustrating an example of a use scene and a system configuration according to a second embodiment. Reference numeral 101 denotes an open earphone, reference numeral 301 denotes an information presentation apparatus, and reference numeral 302 denotes a sightseeing spot. A tourist uses the open earphones 101 to listen to explanation of the sightseeing spot 302 with the information presentation apparatus 301. Each of the left and right open earphones in the second embodiment includes a vibration generator (not illustrated).

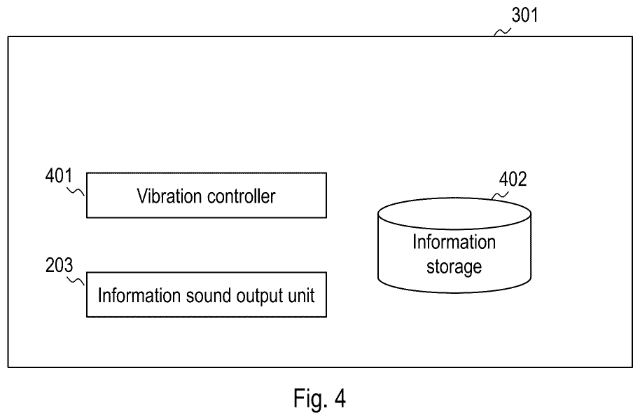

FIG. 4 is a functional block diagram illustrating a configuration example of the information presentation apparatus 301 according to the second embodiment. The information presentation apparatus 301 includes a vibration controller 401, an information storage 402, and an information sound output unit 203.

In the information storage 402, an information sound subjected to sound image localization according to guide contents is recorded in advance. That is, for example, in a case of information with a signage or a direction, guide voice is subjected to the sound image localization in that direction. In this way, it is emphasized that the guide information sound is a sound emitted from the earphones. For information without a direction, the sound image is localized above the earphone user or in a head that does not make the user feel a special direction so as not to interfere with an ambient sound.

The vibration controller 401 vibrates the earphone on a side that matches contents of the guide information sound. Timing of the vibration is recorded in advance in the information storage 402 in association with the guide information sound.

Note that the sound image separation method may be applied by adding a microphone that collects the ambient sound and a signal processor to the information presentation apparatus 301 and a position of the information sound may be adjusted according to the ambient sound.

### Third Embodiment: Sports Commentary

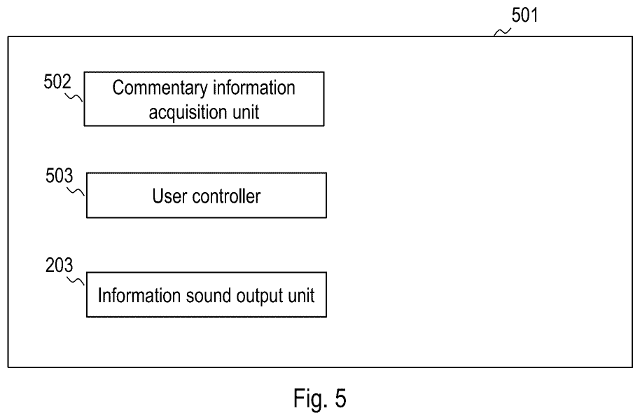

FIG. 5 is a functional block diagram illustrating a configuration example of an information presentation apparatus 501 according to a third embodiment.

Open earphones are used to listen to sports commentary in a stadium. Since the open earphones allow an ambient sound to enter ears as it is, it is possible to listen to sports commentary without impairing a realistic feeling.

Reference numeral 502 denotes a commentary information acquisition unit, reference numeral 503 denotes a user controller, and reference numeral 203 denotes an information sound output unit that outputs an information sound to the open earphones.

The commentary information acquisition unit 502 acquires an information sound to which sound image localization has been applied according to commentary information. An existing wireless communication technology or the like may be used to acquire the information sound.

The user controller 503 operates according to a user's instruction. For example, when the user selects a “focus on game mode”, the user controller 503 lowers volume of the information sound and localizes a sound image of commentary to a position that does not disturb watching, such as behind a head or directly above the head.

A commentary information provider changes a position of the sound image in accordance with movement of a ball or movement of a player while also considering seat positions of spectators watching in the stadium.

In a goal scene of soccer or the like, such a performance may be carried out as moving the sound image position so that commentary voice goes around the user's head.

### Fourth Embodiment: Amusement Performance

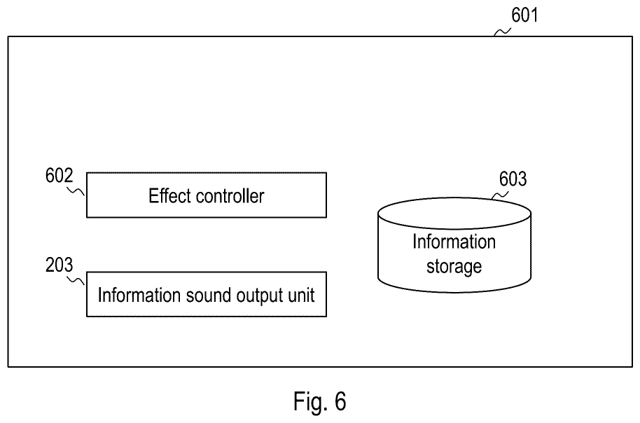

FIG. 6 is a functional block diagram illustrating a configuration example of an information presentation apparatus 601 according to a fourth embodiment.

In a haunted house which is an interactive amusement, open earphones are used for sound production of the haunted house. By using stereophonic sound processing, playback processing is performed as if sound is emitted from a space where no person or object exists.

Reference numeral 602 denotes an effect controller, reference numeral 603 denotes an information storage, and reference numeral 203 denotes an information sound output unit that outputs an information sound to the open earphones.

In the information storage 603 of the information presentation apparatus 601, an information sound subjected to sound image localization in accordance with sound production is recorded in advance. By localizing a sound image not only at a distant position like a stereophonic sound but also at a short distance, an impression that a sound is approaching or a situation of someone talking from directly beside is presented.

The information storage 603 may store binaural recorded sound called ASMR and play the sound with the open earphones.

Furthermore, the effect controller 602 may perform control by adding a function of vibrating, generating heat, or releasing wind or water to the open earphones in addition to sound playback. Timings of vibration, heat generation, or release are recorded in the information storage 603 in advance in association with the performance information sound.

### Fifth Embodiment: Transceiver Adapter

By wearing open earphones on both ears when working using a transceiver, it is possible to cope with surrounding danger or surrounding call under stereo playback without removing one of the earphones.

The transceiver generally has a push-to-talk (PTT) function, which is so configured as to utter while pressing the transceiver and transmit uttered contents. Normally, an utterance is made toward a microphone attached to the transceiver, and an earphone is prepared as an optional item for the transceiver.

The earphone of the transceiver is mainly an earphone for only one ear with a monaural plug. This is because it is assumed that the transceiver does not support transmission of a stereo sound in the first place, and it is assumed that the earphone is worn only on one ear and another ear is kept open to perform work.

However, in a case of such usage, one ear is always blocked, and it is difficult to recognize surrounding sound. In addition, it is difficult to cope with a call from a direction in which the ear is blocked.

Further, there is a problem that a load is applied only to one ear or it is sometimes difficult to listen to unless volume is increased because both ears are not used.

When the open earphones are used, an instruction from the transceiver can be heard while the earphones are worn on both ears, and surrounding sound can be heard without shortage.

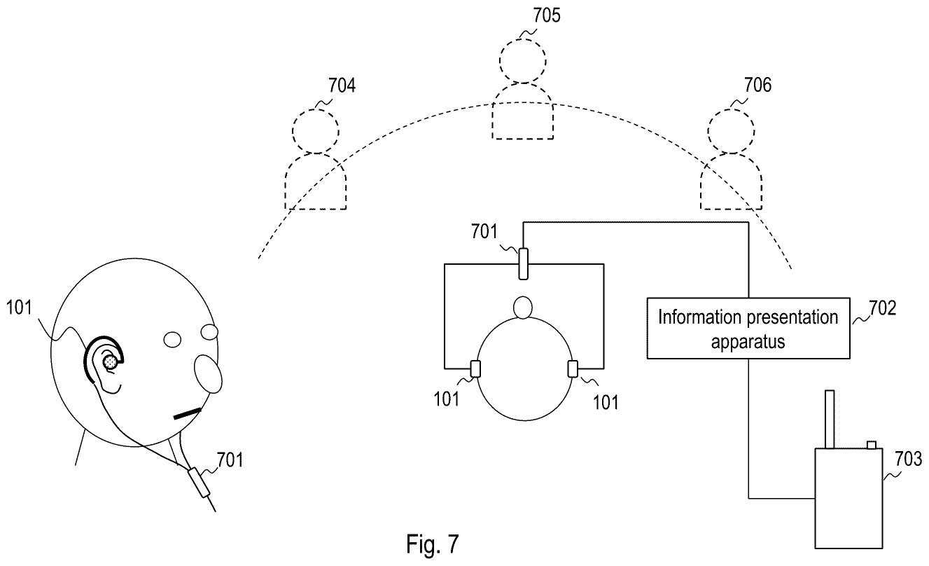

FIG. 7 is a diagram illustrating an example of a use scene and a system configuration according to a fifth embodiment. Reference numeral 101 denotes an open earphone, reference numeral 701 denotes a microphone, reference numeral 702 denotes an information presentation apparatus, reference numeral 703 denotes a transceiver, and reference numerals 704 to 706 denote communication partners by the transceiver.

As illustrated in FIG. 7, the open earphones with the microphone are connected to the existing transceiver via the information presentation apparatus.

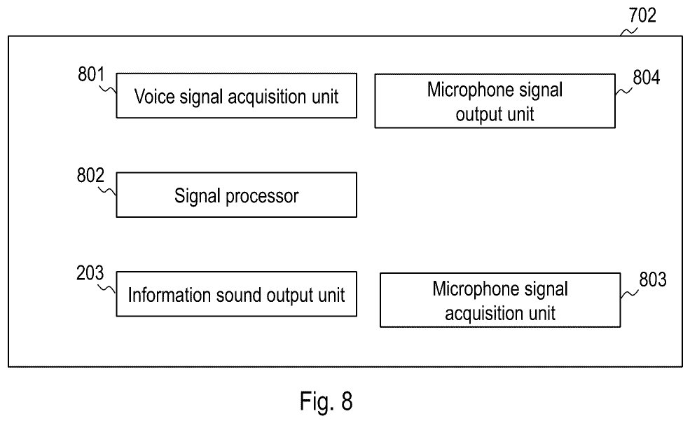

FIG. 8 is a functional block diagram illustrating a configuration example of the information presentation apparatus 702 according to the fifth embodiment. The information presentation apparatus 702 includes a voice signal acquisition unit 801, a signal processor 802, an information sound output unit 203, a microphone signal acquisition unit 803, and a microphone signal output unit 804.

A voice signal output from the transceiver is acquired by the voice signal acquisition unit 801, subjected to predetermined processing by the signal processor 802, and output from the information sound output unit to the open earphones 101.

A user's voice acquired by the microphone signal acquisition unit 803 is output from the microphone signal output unit 804 to the transceiver 703.

### <Call by Plurality of Speakers>

In a call in which a plurality of speakers participates, a spatial audio effect is imparted by taking advantage of wearing earphones on both ears. For example, in a case where there are three speakers at remote locations, the signal processor 802 performs sound image localization so that a first speaker can be heard from 45 degrees left ahead (the speaker 704 in FIG. 7), performs sound image localization so that a second speaker can be heard from the front (the speaker 705 in FIG. 7), and performs sound image localization so that a third speaker can be heard from 45 degrees right ahead (the speaker 706 in FIG. 7) as viewed from an open earphone user.

In the transceiver, since a communication partner is generally specified for each communication channel, a position of a sound image may be changed in conjunction with switching of a channel on which a call is made.

Note that, in a case where there is only one communication partner, the position of the sound image may be arranged at an upper portion using a head-related transfer function.

The fifth embodiment has been described above by taking a case where a communication device is a transceiver as an example, but the communication device may be a smartphone including a call application. In a case of a call application capable of performing simultaneous talking with a plurality of remote places, the information presentation apparatus 702 may acquire communication partner information from the call application and determine a position of a sound image for each communication partner.

Furthermore, each speaker position may be adjusted by applying the sound image separation method to the sound image localization of each speaker by the signal processor 802.

### Sixth Embodiment

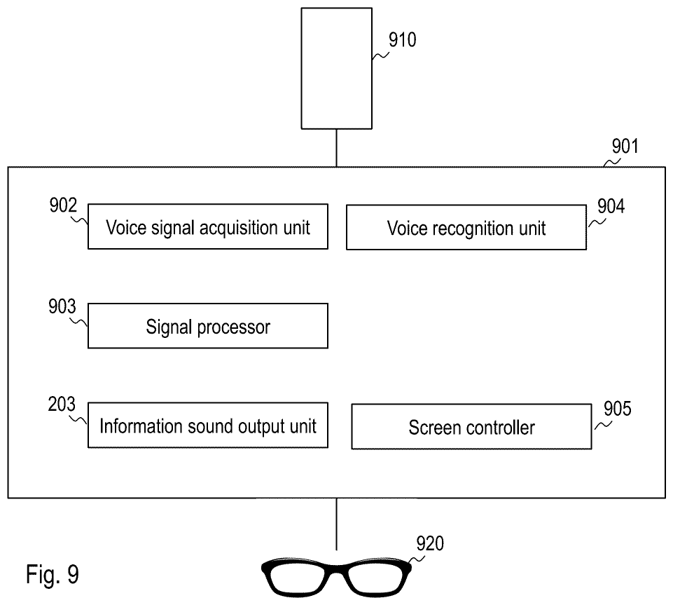

FIG. 9 is a functional block diagram illustrating a configuration example of an information presentation apparatus according to a sixth embodiment.

For example, an information presentation apparatus 901 uses VR glasses 920 with built-in open earphones in order to listen to voice of a wideband speech communication device 910.

Reference numeral 902 denotes a voice signal acquisition unit, reference numeral 903 denotes a signal processor, reference numeral 203 denotes an information sound output unit, reference numeral 904 denotes a voice recognition unit, and reference numeral 905 denotes a screen controller.

The signal processor 903 converts a wideband voice signal acquired by the voice signal acquisition unit 902 into a telephone band voice signal. The information sound output unit outputs the telephone band voice signal to the open earphones.

The voice recognition unit 904 performs voice recognition on the signal acquired by the voice signal acquisition unit 902, and converts the signal into text. The screen controller displays the text obtained by the voice recognition on the VR glasses in synchronization with the output of the information sound.

Note that the screen controller 905 may display, on VR screens, a symbol indicating that the information sound is being output from the open earphones in cooperation with the information sound output unit, instead of displaying the text subjected to the voice recognition on the VR glasses.

### Seventh Embodiment

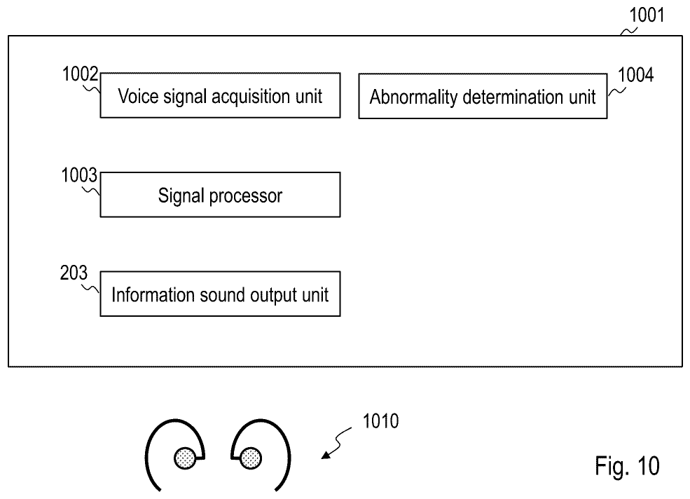

FIG. 10 is a functional block diagram illustrating a configuration example of an information presentation apparatus according to a seventh embodiment.

It is assumed that open earphones 1010 incorporate a posture detector that detects movement of a head of a user. The information presentation apparatus 1001 detects occurrence of abnormality at the user from an output of the posture detector, and performs predetermined control on the open earphones.

Reference numeral 1002 denotes a voice signal acquisition unit, reference numeral 1003 denotes a signal processor, reference numeral 203 denotes an information sound output unit, and reference numeral 1004 denotes an abnormality determination unit.

The abnormality determination unit 1004 acquires a signal of the posture detector (not illustrated), and determines that an abnormality has occurred in the user when movement is not recognized for a predetermined time.

The abnormality determination unit 1004 outputs the occurrence of the abnormality to the signal processor 1003, and the signal processor 1003 controls a sound output from the open earphones to notify the surroundings that the abnormality has occurred to the user. For example, the signal processor 1003 generates a high sound of 3 kHz or more at which sound leakage suppression does not operate and outputs the sound from the information sound output unit 203 to notify the user's surroundings of the occurrence of the abnormality.

Alternatively, the signal processor 1003 controls the open earphones so as to close openings of the open earphones for sound leakage suppression to increase sound leakage and notifies the user's surroundings of the occurrence of the abnormality.

### Program and Recording Medium

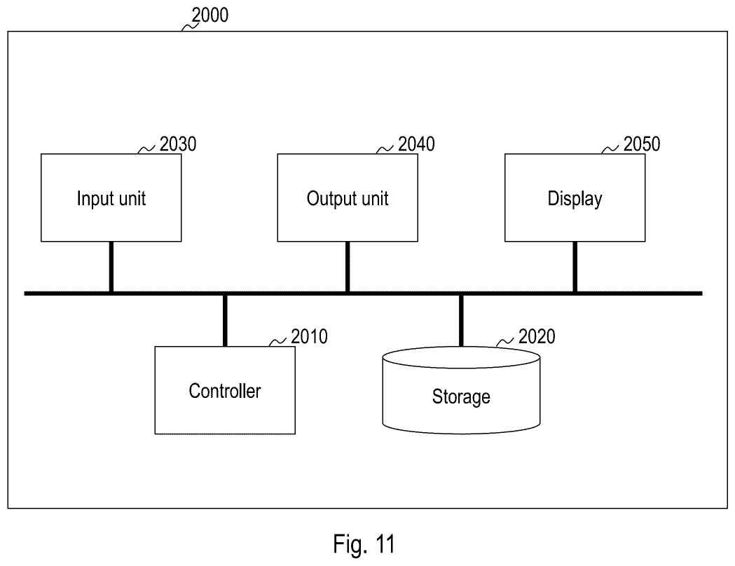

The various processes described above can be performed by causing a storage 2020 of a computer 2000 illustrated in FIG. 11 to record a program for executing each function of the apparatus described above and causing a controller 2010, an input unit 2030, an output unit 2040, a display 2050, and the like to operate.

The program in which the processing content is written can be recorded on a computer-readable recording medium. The computer-readable recording medium may be, for example, any recording medium such as a magnetic recording device, an optical disc, a magneto-optical recording medium, or a semiconductor memory.

Furthermore, distribution of the program is performed by, for example, selling, transferring, or renting a portable recording medium such as a DVD or a CD-ROM on which the program is recorded. Furthermore, the program may be stored in a storage device of a server computer, and the program may be distributed by transferring the program from the server computer to other computers via a network.

For example, a computer that executes such a program first temporarily stores a program recorded on a portable recording medium or a program transferred from a server computer in a storage of its own. Then, when executing processing, the computer reads the program stored in the storage of its own and executes the processing according to the read program. In addition, as another mode of executing the program, the computer may read the program directly from the portable recording medium and execute the processing according to the program, or may sequentially execute processing according to a received program every time the program is transferred from the server computer to the computer. In addition, the above-described processing may be executed by a so-called application service provider (ASP) type service that implements a processing function only by an execution instruction and result acquisition without transferring the program from the server computer to the computer. Note that the program described herein includes information that is used for processing by an electronic computing machine and is equivalent to the program (data or the like that is not a direct command to the computer but has a property that defines processing of the computer).

In the above explanation, the present apparatus is configured by executing a predetermined program on a computer, but at least part of the processing content may be implemented by hardware.

### REFERENCE SIGNS LIST

101 Open earphone
102, 301, 501, 601, 702, 901, 1001 Information presentation apparatus
201, 801, 902, 1002 Voice signal acquisition unit
402, 603 Information storage
502 Commentary information acquisition unit
202 Signal processor
203 Information sound output unit
701 Microphone
2000 Computer
2010 Controller
2020 Storage
2030 Input unit
2040 Output unit
2050 Display

What is claimed is:

1. An information presentation apparatus that identifiably outputs an information sound from open earphones capable of simultaneously hearing an ambient sound and the information sound output from the earphones,
the information presentation apparatus comprising a signal processor that converts the information sound into an identifiable signal,
wherein the identifiable signal is a signal obtained by performing stereophonic sound processing on the information sound or a signal obtained by changing a tone of the information sound.

2. The information presentation apparatus according to claim 1, wherein when the information sound includes voices of a plurality of speakers, a sound image is localized for each of the speakers in the stereophonic sound processing.

3. The information presentation apparatus according to claim 1, wherein when the information sound includes information of a direction or a position, a sound image is localized in the direction or at the position in the stereophonic sound processing.

4. The information presentation apparatus according to claim 1, wherein the signal obtained by changing the tone is obtained by converting wideband voice into telephone band voice.

5. An information presentation apparatus that identifiably outputs an information sound from open earphones capable of simultaneously hearing an ambient sound and the information sound output from the earphones,
the information presentation apparatus comprising:
a signal processor that generates distinguishing information from the information sound; and
a peripheral device that operates according to the distinguishing information or displays the distinguishing information.

6. The information presentation apparatus according to claim 5, wherein
the peripheral device is a vibration generator built in the open earphones, and
the distinguishing information is information for controlling the vibration generator according to a direction information included in the information sound.

7. The information presentation apparatus according to claim 5, wherein
the peripheral device is VR glasses, and
the distinguishing information is text of the information sound or a symbol indicating that the information sound is being output from the open earphones.

8. A non-transitory computer-readable recording medium which stores a program for causing a computer to function as the information presentation apparatus according to claim 1.
